(19) United States
(12) Patent Application Publication
(10) Pub. No.: US 2026/0140918 A1
(43) Pub. Date: May 21, 2026

(54) SYSTEM-ON-CHIP CELLULAR NETWORK SYSTEMS AND METHODS

(71) Applicant: Boost SubscriberCo L.L.C., Englewood, CO (US)

(72) Inventors: Borong Zheng, Littleton, CO (US); In-Kyung Kim, Highlands Ranch, CO (US); Dawood Shahdad, Aurora, CO (US); Sundeep Goswami, Leesburg, VA (US)

(21) Appl. No.: 18/950,831

(22) Filed: Nov. 18, 2024

(51) Int. Cl. G06F 15/78; H04L 41/0806

(52) U.S. Cl. CPC G06F 15/7825; H04L 41/0809

(57) ABSTRACT

A disclosed method may include integrating, on a single System-on-Chip (SoC), a set of 5G or later generation core control plane (CP) functions, a set of 5G or later generation core user plane (UP) functions, a User Plane Function (UPF), and a gNodeB (gNB) for implementing radio access network functionality.

### BRIEF SUMMARY

This disclosure is generally directed to systems, methods, and computer-readable media relating to system-on-chip cellular networks. Dedicated 5G networks may offer significant advantages for enterprise environments, potentially providing enhanced performance, security, and operational control compared to traditional Wi-Fi networks or public cellular services. These networks can be designed to meet specific enterprise requirements, potentially enabling low-latency communications, high device density, and improved reliability for more important applications. The implementation of dedicated 5G networks can enable organizations to tailor their wireless infrastructure to support a wide range of use cases, from connecting large numbers of IoT (Internet of Things) devices in industrial settings to enabling high-bandwidth applications in office environments. By having control over their own 5G network, enterprises may be able to prioritize traffic, manage quality of service, and implement custom security policies that align with their specific needs. Additionally, dedicated 5G networks can potentially offer better coverage in challenging environments, such as large warehouses or manufacturing facilities, where traditional Wi-Fi networks may struggle to provide consistent connectivity.

One challenge that enterprises may face when considering dedicated 5G networks is the complexity of deployment and integration. Traditional 5G network architectures often involve multiple distributed components, which can require specialized expertise to install, configure, and maintain. This complexity may result in longer deployment times and higher operational costs, potentially making it difficult for some enterprises to justify the investment in private 5G technology. The deployment process can involve various steps, including site surveys, spectrum planning, core network setup, radio access network installation, and integration with existing IT systems. Each of these steps may require specific technical knowledge and tools, which may not be readily available within many organizations'IT departments. Furthermore, the ongoing management of a distributed 5G network architecture can be resource-intensive, requiring continuous monitoring, optimization, and troubleshooting to ensure optimal performance. This level of complexity can be particularly challenging for smaller enterprises or those with limited in-house telecommunications expertise, potentially creating a barrier to adoption for organizations that may otherwise benefit from private 5G technology.

A potential solution to this challenge may involve the development of more integrated 5G network solutions. By consolidating multiple network functions into a single system, enterprises may be able to simplify the deployment process and reduce the need for specialized technical knowledge. This technique may potentially lead to faster deployment times and lower operational costs, making dedicated 5G networks more accessible to a wider range of organizations. An integrated solution might combine core network functions, radio access network capabilities, and management interfaces into a unified platform, potentially in the form of a single hardware appliance or a highly integrated software suite. Such a solution may be designed with plug-and-play functionality, enabling for rapid deployment without the need for extensive configuration or integration work. Automated setup and self-optimization features may further simplify the deployment process, potentially enabling non-specialist IT staff to install and manage the dedicated 5G network. By reducing the complexity of deployment and management, integrated solutions may help overcome one of the significant barriers to private 5G adoption, potentially accelerating the technology's uptake across various industries.

Another issue that enterprises may encounter is the scalability of dedicated 5G networks. As businesses grow or their network requirements change, they may need to expand their network capacity or coverage. In some cases, scaling traditional 5G network architectures can be complex, potentially requiring significant reconfiguration or additional hardware deployment. This complexity may lead to disruptions in network service and increased costs associated with network expansion. Scaling challenges can manifest in various ways, such as the need to add capacity to support more devices, extend coverage to new areas of a facility, or enhance performance to support new applications. In distributed architectures, scaling might involve adding new core network components, deploying additional radio units, and reconfiguring the overall network topology. Each of these steps can potentially introduce compatibility issues, require system-wide updates, or necessitate careful load balancing to maintain optimal performance. Furthermore, the interdependencies between different network components can make it difficult to scale individual aspects of the network without impacting others, potentially leading to over-provisioning in some areas and bottlenecks in others.

To address scalability concerns, some techniquees may focus on developing modular and easily expandable network solutions. By designing systems that can be scaled linearly through the addition of standardized components, enterprises may potentially expand their networks more efficiently. This technique may enable smoother capacity increases and coverage extensions without requiring major overhauls of the existing infrastructure. A modular system may be built around a core platform that supports the addition of standardized expansion units, each potentially containing additional processing power, memory, or radio capabilities. These expansion units may be designed to integrate seamlessly with the existing network, automatically configuring themselves and load-balancing with other components. Software-defined networking principles may be employed to enable dynamic resource allocation and network slicing, enabling the network to adapt to changing demands without physical reconfiguration. Additionally, cloud-native architectures may be leveraged to support easier scaling of core network functions, potentially enabling for rapid capacity expansion through software updates or the deployment of additional virtual network functions. By making scalability an inherent feature of the network architecture, these techniques may help ensure that dedicated 5G networks can grow and evolve alongside the enterprises they serve, without incurring prohibitive costs or operational disruptions.

Security and data privacy can be additional areas of concern for enterprises considering dedicated 5G networks. In some network architectures, sensitive data or authentication information may need to be transmitted to or processed by external components, potentially increasing the risk of data breaches or unauthorized access. This can be particularly problematic for organizations in industries with strict regulatory requirements or those handling sensitive information. The distributed nature of traditional 5G architectures can create multiple potential points of vulnerability, each requiring robust security measures. For example, the communication links between different network components, such as between the radio access network and the core network, may need to be encrypted and secured against interception or tampering. User authentication and access control mechanisms may be implemented consistently across all network elements to prevent unauthorized access. Additionally, the integration of dedicated 5G networks with existing enterprise IT systems can create new attack surfaces that need to be managed. There may also be concerns about data sovereignty and compliance with data protection regulations, particularly if any network functions or data storage rely on cloud services or infrastructure located outside the enterprise's direct control.

One potential way to enhance security in dedicated 5G networks may involve the development of self-contained systems that keep sensitive information within the enterprise premises. By processing authentication and encrypting data locally, organizations may be able to maintain greater control over their information and reduce potential attack vectors. This technique may also help enterprises comply with data localization requirements in certain jurisdictions. A self-contained system may integrate robust hardware-based security measures, such as secure enclaves for storing cryptographic keys and processing sensitive operations. End-to-end encryption may be implemented at the hardware level, potentially providing stronger protection against interception or tampering compared to software-based solutions. The system may also incorporate advanced threat detection and response capabilities, leveraging machine learning algorithms to identify and mitigate potential security risks in real-time. By centralizing security functions within a single, controlled environment, this technique may simplify security management and reduce the attack surface of the network. Furthermore, keeping all important network functions and data processing on-premises may help address concerns about data sovereignty and regulatory compliance, potentially making dedicated 5G networks more attractive to organizations in highly regulated industries or those operating in regions with strict data protection laws.

Interoperability with existing enterprise IT systems can present another challenge for dedicated 5G network deployments. In some cases, integrating 5G networks with legacy systems, enterprise applications, or existing network management tools may require complex interfaces or custom development work. This can potentially increase the overall cost and complexity of network deployment and management. Enterprises often have a diverse ecosystem of IT systems, including various databases, enterprise resource planning (ERP) software, customer relationship management (CRM) tools, and industry-specific applications. Ensuring seamless integration between these systems and a new dedicated 5G network can be a complex undertaking. Challenges may arise in areas such as user authentication and access control, where existing enterprise identity management systems need to be integrated with the 5G network's authentication mechanisms. Data exchange between 5G-connected devices and backend enterprise systems may require the development of new APIs or the modification of existing interfaces. Network management and monitoring can also be a point of friction, as enterprises may want to incorporate 5G network metrics and management functions into their existing IT operations platforms. Additionally, ensuring consistent quality of service and policy enforcement across both 5G and non-5G parts of the enterprise network can be challenging, potentially requiring sophisticated traffic management and policy control mechanisms.

To improve interoperability, some solutions may focus on developing standardized interfaces and APIs that enable easier integration with common enterprise IT systems. By providing pre-configured integration options and supporting widely-used protocols, these techniques may potentially simplify the process of connecting dedicated 5G networks with existing enterprise infrastructure and management tools. A comprehensive integration framework may include a library of pre-built connectors for popular enterprise software systems, enabling for rapid integration with minimal custom development. Open APIs may be provided to facilitate the development of custom integrations where needed, potentially using industry-standard protocols such as REST or GraphQL. The solution may also incorporate support for common identity and access management standards, such as SAML or OAuth, to enable seamless integration with enterprise authentication systems. For network management, the system may implement standard protocols like SNMP or modern alternatives like gRPC, enabling for easy incorporation into existing network monitoring and management platforms. Additionally, the solution may offer a unified management interface that provides a single pane of glass for monitoring and controlling both the 5G network and other enterprise network components. This may potentially include features such as integrated policy management, enabling administrators to define and enforce consistent policies across all network types. By prioritizing interoperability and providing flexible integration options, these techniques may help enterprises leverage their existing IT investments while benefiting from the advanced capabilities of dedicated 5G networks.

The cost of deploying and maintaining dedicated 5G networks can be a significant barrier for some organizations. Traditional 5G network architectures may require substantial upfront investments in hardware, software licenses, and specialized personnel. Additionally, ongoing operational costs associated with network management, updates, and troubleshooting can be considerable. The initial capital expenditure for a dedicated 5G network can include costs for core network equipment, radio access network hardware, spectrum licenses (where applicable), and site preparation. These costs can vary widely depending on the size and complexity of the deployment, potentially ranging from hundreds of thousands to millions of dollars for large-scale implementations. Software licensing fees, which may be based on the number of connected devices or the network's capacity, can also contribute significantly to the overall cost. Furthermore, the specialized nature of 5G technology often necessitates the hiring of skilled personnel or extensive training for existing staff, adding to the personnel costs. Ongoing operational expenses can include energy costs for powering network equipment, regular software updates and security patches, hardware maintenance, and potential consulting fees for network optimization and troubleshooting. For many organizations, particularly small and medium-sized enterprises, these costs can make dedicated 5G networks seem prohibitively expensive, potentially limiting the adoption of this technology despite its potential benefits.

To address cost concerns, some techniquees may focus on developing more cost-effective, all-in-one solutions for dedicated 5G networks. By consolidating multiple network functions into a single system and simplifying deployment and management processes, these solutions may potentially reduce both upfront and ongoing costs. This may make private 5G technology more accessible to a wider range of enterprises, including smaller organizations or those with limited IT resources. An all-in-one solution may integrate core network functions, radio access network capabilities, and management interfaces into a single, pre-configured platform. This technique may potentially reduce hardware costs by eliminating the need for multiple separate components. By designing the system for easy deployment and management, the solution may also help reduce installation and operational costs, potentially enabling enterprises to deploy and maintain their dedicated 5G networks with minimal specialized expertise. The use of software-defined networking and network function virtualization technologies may enable more efficient use of hardware resources, potentially enabling for lower-cost hardware to be used without sacrificing performance. Additionally, these solutions may be designed with scalability in mind, enabling enterprises to start with a smaller, more affordable deployment and expand as needed, rather than requiring a large upfront investment. Subscription-based pricing models may be employed to spread costs over time and align expenses with actual usage, potentially making private 5G more financially accessible to a broader range of organizations. By reducing the total cost of ownership for dedicated 5G networks, these techniques may help accelerate adoption and enable more enterprises to benefit from advanced wireless connectivity.

Ensuring consistent performance and quality of service across different enterprise locations or departments can be challenging with some dedicated 5G network architectures. Variations in network configuration, hardware capabilities, or local conditions can potentially lead to inconsistent user experiences or service levels. This issue can be particularly pronounced in large enterprises with multiple sites or complex campus environments. Different locations may have varying requirements in terms of coverage, capacity, and supported applications, making it difficult to implement a one-size-fits-all network solution. Factors such as building layout, materials used in construction, and the presence of interference sources can all impact network performance, potentially requiring site-specific optimizations. In multi-site deployments, maintaining consistent configurations and ensuring seamless roaming between different locations can be challenging, especially if different hardware or software versions are used across sites. Additionally, as new applications and use cases emerge, ensuring that the network can adapt to support them consistently across all locations can be complex. Variations in performance or service quality can lead to user frustration, reduced productivity, and potential issues with important applications that rely on consistent network capabilities.

One way to address this challenge may involve the development of standardized, repeatable deployment models for dedicated 5G networks. By creating pre-configured solutions that can be easily replicated across multiple sites, enterprises may be able to ensure more consistent performance and user experiences. This technique may also potentially simplify network management and reduce the likelihood of configuration errors. A standardized deployment model may include a set of pre-defined network configurations optimized for common enterprise use cases, such as office environments, warehouses, or manufacturing facilities. These configurations may be designed to provide consistent coverage, capacity, and performance characteristics across different locations, while still enabling for some degree of customization to address site-specific requirements. The solution may incorporate advanced self-optimization algorithms that continuously monitor network performance and automatically adjust parameters to maintain consistent service levels. Machine learning techniques may be employed to analyze patterns in network usage and performance across multiple sites, potentially enabling proactive optimizations and predictive maintenance. To support seamless roaming and consistent user experiences across locations, the system may implement centralized user authentication and policy management, ensuring that users have access to the same services and applications regardless of their location within the enterprise network. Additionally, the solution may include tools for centralized management and monitoring of multiple sites, enabling IT teams to easily compare performance metrics, identify potential issues, and apply consistent updates or changes across the entire network. By promoting consistency and standardization in dedicated 5G network deployments, this technique may help enterprises achieve more reliable and uniform wireless connectivity across their operations, potentially improving overall productivity and user satisfaction.

In some examples, a method includes (i) integrating, on a single System-on-Chip (SoC), a set of 5G or later generation core control plane (CP) functions, a set of 5G or later generation core user plane (UP) functions, a User Plane Function (UPF), and a gNodeB (gNB) for implementing radio access network functionality and (ii) configuring the set of CP functions, the set of UP functions, the UPF, and the gNB to communicate with each other within the SoC such that the SoC implements a dedicated 5G or later generation network.

In some examples, the method further comprises implementing a standardized interface protocol on the SoC or pre-configuring network parameters such that the SoC enables plug-and-play deployment of the dedicated 5G or later generation network when connected to an enterprise network.

In some examples, the method further comprises configuring the SoC such that the SoC supports linear scalability by enabling addition of multiple SoCs that each contain at least an instance of the UPF and an instance of the gNB.

In some examples, the method further comprises implementing a hardware-based secure enclave within the SoC that isolates cryptographic operations or stores authentication vectors.

In some examples, the method further comprises implementing a shared memory architecture within the SoC that enables direct data exchange between network functions.

In some examples, the method further comprises providing an interface on the SoC for integration with enterprise IT systems for key performance indicator (KPI) monitoring or billing functions.

In some examples, the method further comprises configuring the SoC such that the SoC supports automated deployment processes that facilitate consistent user experience and service level agreement performance across multiple enterprise installations.

In some examples, the method further comprises implementing a real-time resource allocation algorithm on the SoC that dynamically adjusts computing resources between different network functions based on current network load or user demand.

In some examples, the method further comprises configuring the SoC such that the SoC supports deployment of multiple radio dots.

In some examples, the method further comprises implementing a self-discovery protocol on the SoC that automatically detects network topology or configures routing tables.

In some examples, the method further comprises configuring the gNB such that the gNB supports both public and private spectrum operations.

In some examples, the method further comprises implementing a virtualization layer on the SoC that partitions network resources into multiple isolated virtual networks.

In some examples, the method further comprises further comprising integrating edge computing capabilities within the SoC to support low-latency applications.

In some examples, the method further comprises comprising optimizing the integrated functions to support massive Machine Type Communications (mMTC) for IoT devices.

In some examples, the method further comprises comprising implementing Quality of Service (QoS) management functionality at a hardware level within the SoC.

In some examples, the method further comprises comprising implementing an interface within the SoC to support interoperability with legacy 3G or 4G systems.

In some examples, a non-transitory computer-readable medium has instructions stored thereon that, when executed by at least one physical computing processor, cause a computing device to perform operations comprising (i) integrating, on a single System-on-Chip (SoC), a set of 5G or later generation core control plane (CP) functions, a set of 5G or later generation core user plane (UP) functions, a User Plane Function (UPF), and a gNodeB (gNB) for implementing radio access network functionality and (ii) configuring the set of CP functions, the set of UP functions, the UPF, and the gNB to communicate with each other within the SoC such that the SoC implements a dedicated 5G or later generation network.

In some examples, a system comprises at least one physical computing processor of a computing device and a non-transitory computer-readable medium that has instructions stored thereon that, when executed by the at least one physical computing processor, cause the computing device to perform operations comprising (i) integrating, on a single System-on-Chip (SoC), a set of 5G or later generation core control plane (CP) functions, a set of 5G or later generation core user plane (UP) functions, a User Plane Function (UPF), and a gNodeB (gNB) for implementing radio access network functionality and (ii) configuring the set of CP functions, the set of UP functions, the UPF, and the gNB to communicate with each other within the SoC such that the SoC implements a dedicated 5G or later generation network.

### BRIEF DESCRIPTION OF THE DRAWINGS

For a better understanding of the present invention, reference will be made to the following Detailed Description, which is to be read in association with the accompanying drawings:

FIG. 1 shows an example flow diagram for a method relating to System-on-Chip cellular network systems.

FIG. 2 illustrates an example comprehensive system architecture for an enterprise 5G network deployment model using a distributed technique.

FIG. 3 depicts an example evolved system architecture for an enterprise 5G network deployment model using an integrated System-on-Chip technique.

FIG. 4 shows an example detailed illustration of a System-on-Chip (SoC) architecture for a dedicated 5G network.

FIG. 5 illustrates an example of linear scalability in a System-on-Chip (SoC) based dedicated 5G network deployment across different scales of enterprise environments.

FIG. 6 demonstrates an example plug-and-play deployment process for a System-on-Chip (SoC) based dedicated 5G network in an enterprise setting.

FIG. 7 shows an example illustration of enhanced security features in a System-on-Chip (SoC) for a dedicated 5G network.

FIG. 8 illustrates an example of enterprise IT integration and KPI monitoring in a System-on-Chip (SoC) based dedicated 5G network.

FIG. 9 depicts an example of radio dot deployment and network topology in a System-on-Chip (SoC) supported dedicated 5G network setup.

FIG. 10 shows an example system diagram of a computing system that may be used to implement embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

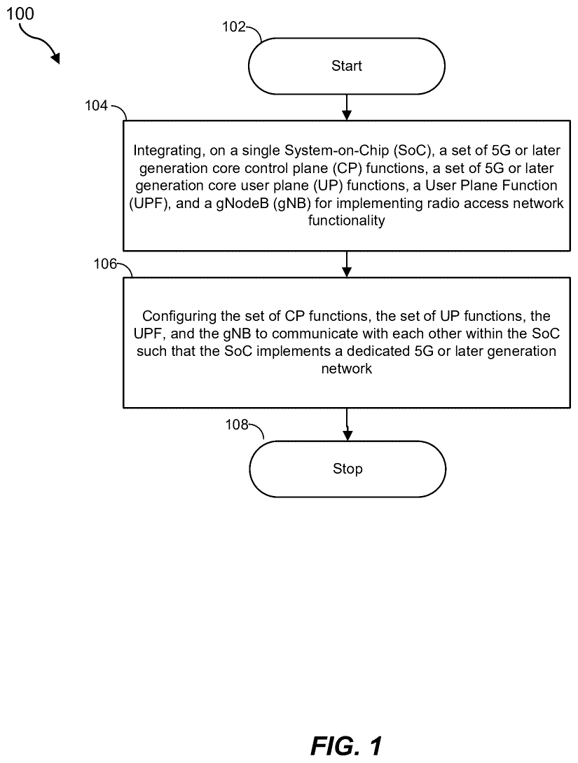

FIG. 1 shows a flow diagram for a method 100 relating to cellular coverage acquisition. At step 102, method 100 may start. At step 104, method 100 includes integrating, on a single System-on-Chip (SoC), a set of 5G or later generation core control plane (CP) functions, a set of 5G or later generation core user plane (UP) functions, a User Plane Function (UPF), and a gNodeB (gNB) for implementing radio access network functionality. At step 106, method 100 includes configuring the set of CP functions, the set of UP functions, the UPF, and the gNB to communicate with each other within the SoC such that the SoC implements a private 5G or later generation network. At step 108, method 100 ends.

As used herein, a network may be dedicated in the sense that the network better fits a description of a private, locally-deployed, or enterprise-deployed network through a SoC architecture, consistent with the general discussion of the figures, than a more related or traditional public network operated by a mobile network operator and available to public subscribers. Factors to consider when evaluating a whether a network is dedicated may include (i) the allocation of infrastructure specifically for an organization or enterprise use, such as the deployment of SoC-based network components within the enterprise premises or for the enterprise's predominant or exclusive use; (ii) the implementation of controlled access mechanisms, where network access is managed and limited to authorized users within the organization or designated entities, potentially through enterprise-specific authentication and authorization systems; (iii) the degree of customized management, allowing the organization significant control over network management, security protocols, and data handling procedures, which may include the ability to directly configure network functions and implement enterprise-specific policies; (iv) the extent of tailored functionality, where the network can be customized to meet specific enterprise needs, preferences, and use cases, such as supporting particular industrial applications, IoT deployments, or enterprise-specific services; and (v) the flexibility in spectrum usage, which may involve the utilization of licensed, unlicensed, or shared spectrum depending on the specific deployment scenario and regulatory environment.

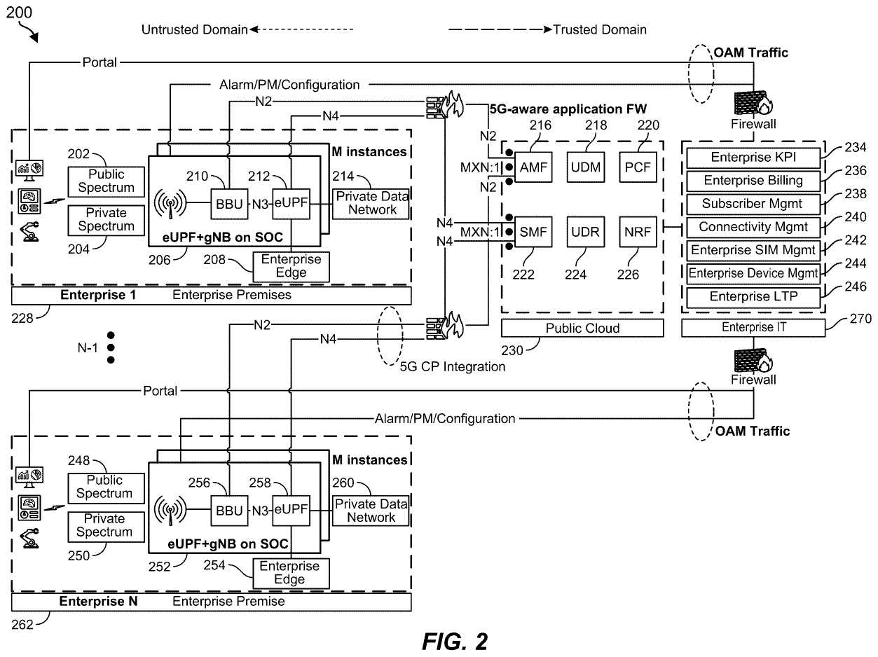

FIG. 2 illustrates an example comprehensive system architecture 200 for an enterprise 5G network deployment model. This figure presents a detailed view of the various components and their interconnections, which shows a technique to implementing dedicated 5G networks within enterprise environments. The architecture depicted in FIG. 2 may address several challenges associated with traditional 5G network deployments, potentially offering enhanced scalability, simplified integration, and improved security for enterprise users. The system 200 is divided into three main sections: the top-left section representing the enterprise premises for Enterprise 1 228, the top-right section depicting the core network functions and Enterprise IT systems 270, and the bottom-left section showing a similar setup for Enterprise N 262. This layout may illustrate how the architecture can support multiple enterprise deployments while maintaining a centralized core network infrastructure, potentially enabling efficient management and resource utilization across diverse enterprise environments.

In the top-left section, the Enterprise 1 228 includes both public spectrum 202 and private spectrum 204 capabilities. This dual-spectrum technique may provide flexibility in network deployment, potentially enabling enterprises to leverage both licensed and unlicensed frequency bands for optimal coverage and capacity. The ability to utilize both public and private spectrum may offer significant advantages in terms of network performance and reliability. For instance, private spectrum may be used for important applications requiring guaranteed bandwidth and low latency, while public spectrum may be leveraged for less demanding tasks or to supplement capacity during peak usage periods. This flexibility may be particularly valuable in complex enterprise environments where different areas or applications may have varying connectivity requirements. The central component of this section is the System-on-Chip (SoC) 206, which integrates an embedded User Plane Function (eUPF) and gNodeB (gNB) on a single chip. This integration may represent a significant advancement in 5G network architecture, potentially reducing complexity and improving efficiency in private network deployments. By combining these functions on a single chip, the SoC 206 may offer benefits such as reduced power consumption, lower latency, and simplified network management. This integrated technique may be particularly advantageous for enterprises seeking to deploy dedicated 5G networks without the need for extensive telecommunications expertise or complex infrastructure.

Within the SoC 206, a Baseband Unit (BBU) 210 and an eUPF 212 are connected via an N3 interface. This tight coupling of radio access and user plane functions on a single chip may offer several advantages, such as reduced latency and improved resource utilization. The close proximity of these components may enable more efficient data processing and routing, potentially enhancing overall network performance. The eUPF 212 is also connected to a Private Data Network 214, which may enable secure and direct access to enterprise resources without routing traffic through external networks. This direct connection may be helpful for enterprises handling sensitive data or requiring strict control over data flows. The architecture's design may enable enterprises to maintain data sovereignty and comply with various regulatory requirements by keeping data within their private network boundaries. Furthermore, the enterprise edge 208 is shown connected to the eUPF 212, potentially enabling edge computing capabilities and localized data processing. This edge integration may be particularly beneficial for applications requiring low latency or high bandwidth, such as industrial IoT or augmented reality systems. By processing data closer to its source, enterprises may be able to reduce backhaul traffic, improve response times, and enhance the overall efficiency of their operations.

The top-right section of FIG. 2 depicts the core network functions and enterprise IT systems, illustrating a comprehensive set of components that may work together to provide a full-featured dedicated 5G network solution. This section includes 5G core network elements such as the Access and Mobility Management Function (AMF) 216, Unified Data Management (UDM) 218, Policy Control Function (PCF) 220, Session Management Function (SMF) 222, Unified Data Repository (UDR) 224, and Network Repository Function (NRF) 226. These components are shown behind a “5G-aware application FW” label, suggesting the implementation of a specialized firewall to secure the core network functions. The presence of this firewall may indicate a strong focus on security, potentially protecting important network functions from unauthorized access or cyber threats. The arrangement of these core network functions in a centralized manner may offer several advantages, such as simplified management, efficient resource allocation, and the ability to apply consistent policies across multiple enterprise deployments. Below these core network functions, the figure shows a public cloud 230, which may suggest the possibility of leveraging cloud resources for certain network functions or data processing tasks. This hybrid technique, combining on-premises components with cloud capabilities, may offer enterprises greater flexibility in scaling their networks and accessing advanced services.

The connections between the enterprise premises and the core network are illustrated with N2 and N4 interfaces, labeled with “M×N:1” designations. This notation may indicate a scalable architecture where multiple enterprise deployments (N) can connect to a single set of core network functions (1), potentially offering significant advantages in terms of network management and resource utilization. This design may enable efficient scaling of the network to support multiple enterprise locations or departments while maintaining centralized control and consistent policies. The use of standardized interfaces like N2 and N4 may also facilitate interoperability and future upgradability, enabling enterprises to evolve their networks as new technologies and capabilities become available. The scalability demonstrated in this architecture may be particularly valuable for large enterprises with multiple sites or for managed service providers looking to offer dedicated 5G networks to multiple clients using a shared core infrastructure.

The enterprise IT section includes various management and operational support systems, such as Enterprise KPI 234, Enterprise Billing 236, Subscriber Management 238, Connectivity Management 240, Enterprise SIM Management 242, Enterprise Device Management 244, and Enterprise LTP 246, which are adjacent Enterprise IT 270. These systems may provide comprehensive tools for monitoring, managing, and optimizing the dedicated 5G network, potentially enabling enterprises to maintain full control over their network operations. The inclusion of these management systems within the enterprise IT domain suggests a high degree of customization and control available to the enterprise. For example, the Enterprise KPI 234 system may enable detailed monitoring of network performance metrics, enabling proactive optimization and troubleshooting. The Enterprise Billing 236 and Subscriber Management 238 systems may provide granular control over user access and usage tracking, potentially enabling enterprises to implement custom pricing models or departmental charge-back systems. The presence of Enterprise SIM Management 242 and Enterprise Device Management 244 systems may indicate advanced capabilities for managing a diverse ecosystem of devices, from smartphones and tablets to IoT sensors and industrial equipment. This comprehensive set of management tools may be helpful for enterprises seeking to leverage their dedicated 5G networks for digital transformation initiatives or to support complex operational requirements.

The bottom-left section of FIG. 2 shows a similar setup for Enterprise N 262, illustrating how the architecture can scale to support multiple enterprise deployments. This scalability may be a key feature of the system, potentially enabling for efficient expansion of dedicated 5G networks across various enterprise locations or departments. This also includes public spectrum 248, private spectrum 250, and enterprise edge 254, as shown, and parallel to the top-left of the figure. The replication of components such as the SoC 252, BBU 256, and eUPF 258 for Enterprise N demonstrates how the architecture can be consistently applied across multiple sites. eUPF 258 may connect to a private data network 260, as shown. This consistency may be valuable for enterprises with distributed operations, enabling them to maintain uniform network capabilities and management practices across all locations. The scalability of this architecture may also offer benefits in terms of cost-effectiveness, as it may enable enterprises to start with a small deployment and gradually expand their network as needs grow, without requiring significant changes to the overall architecture.

Throughout the figure, several security measures are depicted, including firewalls between different sections and the designation of “Untrusted Domain” and “Trusted Domain” at the top of the diagram. These elements may highlight the system's approach to security, potentially offering enhanced protection for sensitive enterprise data and communications. The clear delineation between trusted and untrusted domains may be particularly important for enterprises dealing with sensitive information or operating in regulated industries. The implementation of multiple firewalls at various points in the architecture suggests a defense-in-depth technique to security, potentially providing protection against a wide range of threats. This comprehensive security technique may be a significant advantage for enterprises concerned about the potential risks associated with wireless networks, particularly in an era of increasing cyber threats and data privacy regulations.

The figure also shows alarm, performance management (PM), and configuration data flows, as well as Operation, Administration, and Maintenance (OAM) traffic. These connections may indicate comprehensive management and monitoring capabilities, potentially enabling proactive maintenance and efficient network operations. The presence of these management flows across different parts of the architecture suggests a holistic technique to network management, where administrators can have visibility and control over all aspects of the network, from core functions to edge devices. This level of control and visibility may be helpful for maintaining high levels of network performance and reliability, which are often important requirements for enterprise operations.

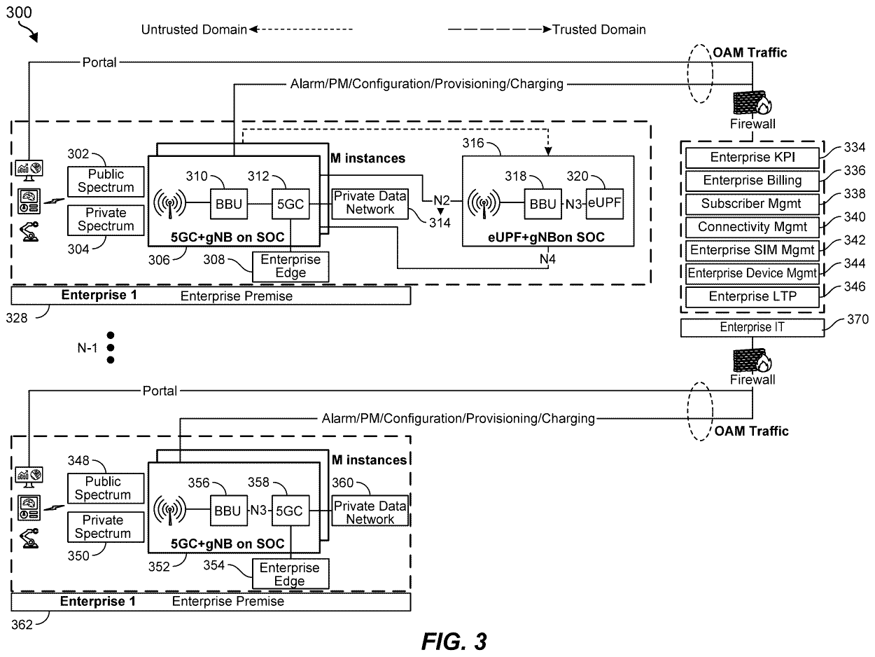

FIG. 3 illustrates an evolved system architecture 300 for an enterprise 5G network deployment model, building upon the concepts presented in FIG. 2 while introducing significant modifications that may offer enhanced integration and efficiency. This figure retains many of the elements from the previous architecture but presents a novel technique to the centralized network functions, potentially addressing challenges related to scalability, security, and operational complexity in dedicated 5G network deployments. The architecture depicted in FIG. 3 represents a significant evolution in the concept of dedicated 5G networks. This new technique may address several challenges identified in traditional 5G network deployments, particularly in the context of enterprise environments where simplicity, scalability, and security are considerations.

The most notable change in FIG. 3 is the replacement of the separate core network functions (previously shown as elements 216-226 and 230 in FIG. 2) with a single System-on-Chip (SoC) 316. This SoC 316 integrates a Baseband Unit (BBU) 318 and an embedded User Plane Function (eUPF) 320, connected internally. This consolidation of core network functions into a single SoC represents a significant shift in the architecture, potentially offering several advantages in terms of network performance, management, and deployment flexibility. By consolidating multiple network functions onto a single chip, the architecture may address the challenges of operational complexity and integration costs that were highlighted as significant barriers to adoption in related deployment models. The SoC technique may enable a more streamlined deployment process, potentially enabling enterprises to implement dedicated 5G networks with the ease and flexibility comparable to Wi-Fi systems.

The integration of core network functions into the SoC 316 may result in reduced latency and improved overall network efficiency. By bringing these functions closer together within a single chip, data processing and routing between different network elements may potentially be optimized, leading to faster response times and more efficient resource utilization. This integrated technique may be particularly beneficial for applications requiring low latency or high bandwidth, such as industrial IoT or real-time control systems. For example, keeping all call processing local can lead to faster and more efficient communication. The SoC-based architecture directly addresses this goal by integrating network functions, potentially eliminating the need for external communication and processing that may introduce delays. Furthermore, this integration may simplify the network topology, reducing the number of potential points of failure and streamlining the data flow within the network. This simplification may contribute to the overall reliability and performance of the dedicated 5G network.

The SoC 316 is connected to the enterprise premises SoC 306 via an N4 interface, maintaining the scalable architecture where multiple enterprise deployments can connect to a centralized set of core network functions. This design may continue to offer advantages in terms of network management and resource utilization while potentially simplifying the overall network topology. The consolidation of core functions into a single SoC may also enhance security by reducing the number of potential attack vectors and simplifying the implementation of security measures. This technique aligns with the inventors'emphasis on enhanced security, as mentioned in the transcript. By keeping all sensitive user information and authentication vectors local within the SoC, the architecture may provide improved security for both the enterprise and the network operator. The reduced attack surface and simplified security implementation may be particularly valuable in industries handling sensitive data or subject to strict regulatory requirements. Additionally, the local processing of authentication and user data may help address concerns related to data sovereignty and privacy, which are increasingly important considerations for enterprises deploying private networks.

The enterprise IT section 370 (elements 334-346) remains largely unchanged from FIG. 2, indicating that the management and operational support systems can seamlessly integrate with this new SoC-based core network architecture. This compatibility may enable enterprises to maintain their existing management practices and tools while benefiting from the enhanced capabilities of the integrated SoC technique. The retention of these elements demonstrates the architecture's flexibility in accommodating various enterprise IT systems and cloud integration scenarios. This flexibility may be helpful for enterprises seeking to leverage their existing IT investments while adopting advanced 5G capabilities. The figure thereby highlights a private 5G solution that can compete effectively with Wi-Fi in terms of ease of use and integration within existing enterprise environments. The ability to maintain familiar management interfaces and practices while gaining the benefits of 5G technology may be a significant factor in driving adoption among enterprises that may be hesitant to overhaul their entire network infrastructure.

The implications of this architectural shift may be far-reaching for enterprise 5G network deployments. By consolidating core network functions into a single SoC, the system may offer improved scalability and flexibility. Enterprises may be able to deploy dedicated 5G networks more easily, potentially reducing the need for specialized expertise and complex integration efforts. This simplified architecture may make dedicated 5G networks more accessible to a wider range of organizations, including smaller enterprises or those with limited telecommunications experience. The figure further highlights how the SoC-based technique supports linear scalability that aligns directly with the growing needs of enterprise environments. This linear scalability may be achieved through the ability to add multiple SoCs as needed, each containing the important functions to extend network coverage and capacity. Unlike traditional architectures that may face quadratic scaling challenges, particularly in terms of integration complexity, the SoC-based technique may enable more predictable and manageable network growth. This scalability feature may be particularly valuable for enterprises with evolving connectivity needs or those planning for future expansion, as it may provide a clear and cost-effective path for network growth without requiring significant re-architecture or disruption to existing operations.

Furthermore, the SoC-based technique may offer significant benefits in terms of energy efficiency and space utilization. By integrating multiple functions into a single chip, the overall power consumption and physical footprint of the network infrastructure may potentially be reduced. This efficiency may translate into cost savings for enterprises, both in terms of initial deployment and ongoing operational expenses. The compact nature of the SoC solution may also make it easier to deploy in diverse enterprise environments, from office buildings to industrial facilities, where space for network equipment may be limited. The energy efficiency aspect aligns with growing corporate sustainability initiatives and may provide an additional incentive for enterprises to adopt this technology. Moreover, the reduced infrastructure requirements may potentially lower the barrier to entry for private 5G adoption, making it a viable option for a broader range of organizations that may have previously considered such networks too complex or costly to implement.

The consolidated SoC architecture may also provide advantages in terms of network upgrades and evolution. With core functions integrated into a single chip, software updates and feature enhancements may potentially be applied more uniformly and efficiently across the entire network. This may enable enterprises to more easily keep pace with advancing 5G technologies and emerging use cases, ensuring that their private networks remain capable of supporting evolving business needs. The simplified upgrade process may address concerns about the complexities of maintaining compatibility between different network components in traditional architectures. In the SoC-based model, upgrades may potentially be applied to the entire integrated system simultaneously, reducing the risk of compatibility issues and simplifying the overall maintenance process. This ease of upgrading may be particularly valuable in the rapidly evolving 5G landscape, where new features and capabilities are continually being developed. Enterprises adopting this architecture may be better positioned to take advantage of future 5G advancements without the need for costly and disruptive hardware replacements or complex integration efforts.

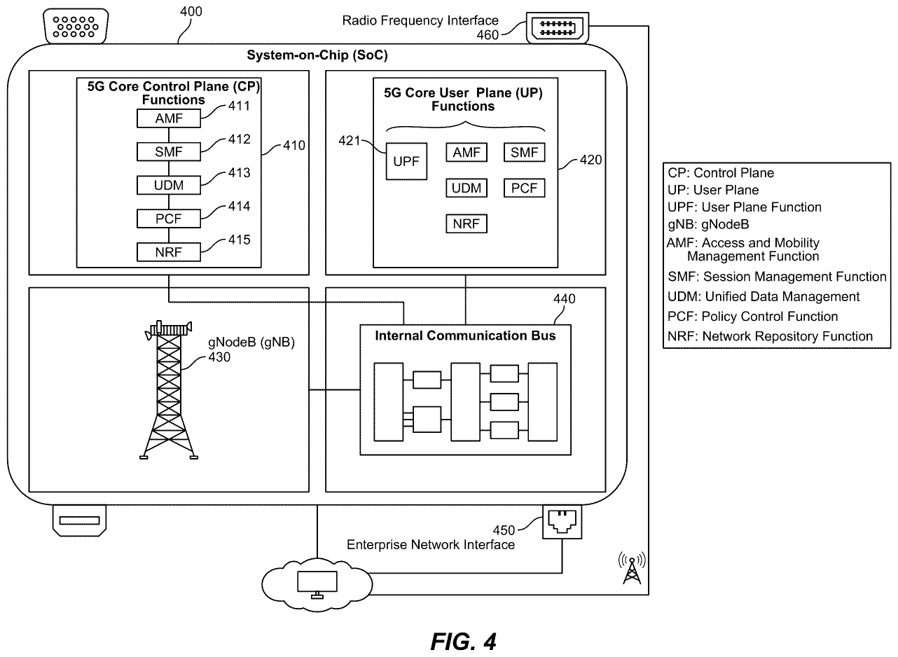

FIG. 4 illustrates a comprehensive System-on-Chip (SoC) architecture 400 for a dedicated 5G network. The figure shows a large rectangular chip with rounded corners, reminiscent of a modern processor chip, occupying most of the drawing space. The SoC 400 is divided into four main sections, each clearly labeled and separated by lines, representing different functional components of the 5G network integrated onto a single chip. This integrated technique may offer several potential benefits in terms of network performance, efficiency, and deployment simplicity. By consolidating multiple network functions onto a single chip, the SoC 400 architecture may reduce overall system complexity, potentially streamlining network deployment and management processes. In some scenarios, this consolidation may lead to reduced latency and improved performance, as data may be processed and transferred more quickly between different network functions when they are in close proximity on the same chip. Additionally, this integrated design may enhance security by reducing the number of external interfaces and potential attack vectors, which may be particularly beneficial in enterprise environments where data protection is a high priority. The compact nature of the SoC 400 may also provide a more energy-efficient solution compared to distributed systems, potentially making it well-suited for enterprise environments with space or power constraints. These potential advantages may make dedicated 5G networks more accessible and manageable for a wide range of enterprise applications, from small offices to large industrial settings.

In the top-left section of the SoC 400, the figure displays a group of interconnected blocks labeled “5G Core Control Plane (CP) Functions 410”. This section includes smaller blocks representing control plane functions: Access and Mobility Management Function (AMF) 411, Session Management Function (SMF) 412, Unified Data Management (UDM) 413, Policy Control Function (PCF) 414, and Network Repository Function (NRF) 415. The integration of these functions onto a single chip may offer several advantages in terms of network performance and efficiency. For instance, the close proximity of these components may enable faster communication and coordination between different control plane functions, potentially reducing latency and improving overall network responsiveness. In some embodiments, this integrated technique may simplify network management by eliminating the need for separate hardware components for each function, potentially reducing maintenance overhead and improving system reliability. The AMF 411 may handle tasks such as user authentication and mobility management, while the SMF 412 may manage session establishment and quality of service. The UDM 413 may store and manage user subscription data, the PCF 414 may handle policy decisions for network behavior, and the NRF 415 may maintain a repository of available network functions. By having these functions tightly integrated on the SoC 400, the system may be able to make more efficient use of resources and respond more quickly to changing network conditions or user demands.

The top-right section of the SoC 400 shows another group of blocks labeled “5G Core User Plane (UP) Functions 420”. Within this section, a prominent block labeled “UPF 421” (User Plane Function) is displayed, along with several smaller blocks representing other user plane functions. The integration of user plane functions alongside control plane functions on the same chip may offer significant benefits in terms of data processing efficiency and reduced latency. By having the UPF 421 in close proximity to the control plane functions, the SoC 400 may be able to handle data traffic more efficiently, potentially improving overall network performance and user experience. In some scenarios, this integration may enable more dynamic and responsive traffic management, as the UPF 421 may be able to quickly adapt to changing network conditions based on real-time input from the control plane functions. The UPF 421 may handle tasks such as packet routing and forwarding, quality of service enforcement, and data buffering. The other user plane functions represented by the smaller blocks may include capabilities such as deep packet inspection, traffic shaping, and network address translation. By consolidating these functions on the SoC 400, the system may be able to process data traffic with lower latency and higher throughput compared to traditional distributed architectures, potentially leading to improved performance for latency-sensitive applications such as real-time video streaming or industrial control systems.

In some examples, the method may further comprise implementing Quality of Service (QoS) management functionality at a hardware level within the SoC. This hardware-based technique may enable more precise and efficient control over network resources, potentially enabling for better performance guarantees for more important applications and more effective prioritization of different types of traffic. By implementing QoS mechanisms directly in hardware, the SoC may potentially process and enforce QoS policies with lower latency and higher throughput compared to software-based solutions.

The hardware-level QoS management might include dedicated circuitry for packet classification, enabling the SoC to quickly categorize incoming traffic based on various criteria such as source, destination, protocol, or application type. It may also incorporate hardware queues with sophisticated scheduling algorithms to ensure that high-priority traffic is processed promptly while still providing fair access for lower-priority data. Additionally, the SoC might include hardware-accelerated traffic shaping capabilities to control bandwidth usage and enforce rate limits for different traffic classes.

This hardware-based QoS technique may be particularly valuable in enterprise environments where different applications have varying performance requirements. For instance, it may ensure that time-sensitive traffic, such as voice or video communications, receives priority treatment to maintain low latency and jitter, while simultaneously managing bandwidth for less important applications like file transfers or software updates.

Furthermore, the hardware-level QoS management may potentially adapt to changing network conditions in real-time. By closely monitoring network performance metrics, the SoC may dynamically adjust QoS parameters to optimize overall network efficiency and maintain service quality even under challenging conditions. This adaptive capability, combined with the efficiency of hardware-based processing, may enable the SoC to provide more consistent and reliable performance across a wide range of network scenarios, from normal operations to peak load situations or during partial network outages.

In the bottom-left section of the SoC 400, the figure depicts a detailed illustration of a miniature cell tower labeled “gNodeB (gNB) 430”. This representation of the radio access network component within the chip architecture demonstrates the comprehensive nature of the SoC 400, integrating not only core network functions but also radio access capabilities. This integration may offer several advantages, such as reduced deployment complexity and improved coordination between core network functions and radio access components. By having the gNB 430 on the same chip as the core network functions, the SoC 400 may be able to optimize radio resource management and improve overall network efficiency. In some embodiments, this tight integration may enable more advanced features such as network slicing, where the gNB 430 and core network functions work closely together to provide customized network characteristics for different services or user groups. The gNB 430 may handle tasks such as radio transmission and reception, signal processing, and initial access procedures for user devices. By incorporating these functions into the SoC 400, the system may be able to provide a more compact and efficient solution for dedicated 5G networks, potentially reducing the need for extensive external radio equipment and simplifying network deployment in enterprise environments.

In some examples, the method may further comprise optimizing the integrated functions to support massive Machine Type Communications (mMTC) for IoT devices. This optimization may involve tailoring various aspects of the SoC's functionality to efficiently handle the unique characteristics of IoT traffic, such as large numbers of connected devices, small data payloads, and intermittent communication patterns. By specifically addressing the needs of IoT deployments, this technique may enable the SoC to support a much higher density of connected devices compared to traditional cellular networks.

The optimization for mMTC might include implementing efficient signaling protocols to reduce overhead for small data transmissions, employing advanced scheduling algorithms to manage access for a large number of devices, and/or incorporating power-saving features to extend the battery life of IoT sensors. The SoC may also include specialized hardware accelerators designed to process the types of data commonly generated by IoT devices, such as environmental sensor readings or status updates from industrial equipment.

Furthermore, this optimization may extend to the network management layer, with the SoC incorporating features like group-based device management, automated provisioning for large numbers of devices, and analytics capabilities tailored to IoT use cases. These enhancements may enable enterprises to deploy and manage large-scale IoT networks more efficiently, potentially opening up new possibilities for applications in areas such as smart manufacturing, logistics, and building automation.

The bottom-right section of the SoC 400 shows a set of connecting buses and interfaces, labeled “Internal Communication Bus 440”. Lines are shown connecting this bus to all other sections of the chip, illustrating how the various components of the SoC 400 communicate with each other. This internal communication architecture may play a role in enabling efficient data exchange between different network functions, potentially reducing latency and improving overall system performance. The integrated nature of this communication bus may also offer advantages in terms of power efficiency and reduced complexity compared to traditional distributed network architectures. In some scenarios, the Internal Communication Bus 440 may support high-speed, low-latency communication between different functional blocks, enabling for more efficient coordination and data sharing. This may be particularly beneficial for tasks that require rapid interaction between control plane and user plane functions, or between the core network and radio access components. The bus architecture may also provide flexibility for future upgrades or modifications, potentially enabling for the addition or reconfiguration of network functions without requiring changes to the underlying hardware.

In some examples, the method may further comprise implementing a virtualization layer on the SoC that partitions network resources into multiple isolated virtual networks. This virtualization capability may enable the creation of logically separated network slices, each potentially tailored to specific applications, departments, or service levels within an enterprise. By abstracting the underlying physical network resources, the virtualization layer may enable more flexible and efficient utilization of the SoC's capabilities.

Each virtual network created by this layer may have its own set of allocated resources, including processing power, memory, and network bandwidth. This isolation may provide enhanced security and performance guarantees, as activities in one virtual network would not interfere with others. For instance, an enterprise may create separate virtual networks for its financial department, research and development team, and guest access, each with its own security policies and performance characteristics.

The virtualization layer may also facilitate easier network management and scaling. As enterprise needs evolve, new virtual networks may be created or existing ones modified without necessitating changes to the underlying physical infrastructure. This flexibility may be particularly valuable in dynamic business environments or for managed service providers supporting multiple clients on a single physical infrastructure.

In some examples, the method may further comprise implementing a real-time resource allocation algorithm on the SoC that dynamically adjusts computing resources between different network functions based on current network load or user demand. This algorithm may continuously monitor the utilization of various network functions and/or redistribute processing power, memory, and other resources as needed to optimize overall system performance. For instance, during periods of high data traffic, the algorithm might allocate more resources to the User Plane Function (UPF) to handle increased packet processing demands. Conversely, during times of frequent user mobility, it may prioritize resources for the Access and Mobility Management Function (AMF) to manage handovers more efficiently.

The real-time nature of this resource allocation may enable the SoC to adapt swiftly to changing network conditions, potentially improving user experience and maximizing resource efficiency. This dynamic technique may be particularly valuable in enterprise environments where network usage patterns can vary significantly throughout the day or in response to specific events. By ensuring that resources are allocated where they are needed, the system may be able to maintain consistent performance even under fluctuating demand, potentially reducing the need for over-provisioning of hardware resources.

Around the edges of the SoC 400, the figure shows several interface ports. Two of these ports are specifically labeled: “Enterprise Network Interface 450” and “Radio Frequency Interface 460”. These interfaces illustrate how the SoC 400 may connect to external network components and devices. The Enterprise Network Interface 450 may enable seamless integration with existing enterprise IT infrastructure, potentially simplifying deployment and management of the dedicated 5G network. This interface may support various protocols and standards commonly used in enterprise networking, enabling easy connection to existing switches, routers, and servers. In some embodiments, the Enterprise Network Interface 450 may also provide a path for network management and monitoring tools to access the SoC 400, enabling for centralized control and visibility of the dedicated 5G network. The Radio Frequency Interface 460 may enable the SoC 400 to communicate with user devices and other radio access network components, facilitating wireless connectivity. This interface may support multiple frequency bands and radio access technologies, potentially enabling the SoC 400 to adapt to different deployment scenarios and regulatory requirements. The integration of these interfaces on the SoC 400 may contribute to the system's flexibility and ease of deployment in various enterprise environments.

In some examples, the method may further comprise implementing an interface within the SoC to support interoperability with legacy 3G or 4G systems. This interface may enable seamless integration of the 5G SoC-based network with existing cellular infrastructure, potentially enabling enterprises to leverage their current investments while transitioning to newer technologies. The interoperability interface might include protocol translation capabilities, signaling adapters, and/or mechanisms for managing handovers between different private generation networks.

By supporting interoperability with legacy systems, the SoC may facilitate a more gradual and flexible migration path to 5G. Enterprises may deploy the SoC-based 5G network in specific areas or for particular use cases while maintaining connectivity with their existing 3G or 4G infrastructure. This technique may be particularly valuable in large campuses or industrial settings where comprehensive 5G coverage might be deployed in phases.

The legacy interoperability interface may also enable advanced features such as dual connectivity, where devices can simultaneously maintain connections to both 5G and legacy networks for improved reliability and performance. Additionally, it might support fallback mechanisms, ensuring that devices can seamlessly transition to 3G or 4G networks in areas where 5G coverage is not yet available, thus providing consistent connectivity across diverse environments.

In some examples, the method may further comprise integrating edge computing capabilities within the SoC to support low-latency applications. By incorporating compute resources directly within the SoC, this technique may enable data processing and analysis to occur closer to the point of data generation, potentially reducing latency and improving overall application performance. This edge computing functionality may be particularly beneficial for applications that require real-time processing, such as industrial automation, augmented reality, or autonomous vehicles.

The integrated edge computing capabilities might include dedicated processing units, local storage, and specialized hardware accelerators designed to handle specific types of workloads efficiently. For instance, the SoC may incorporate AI inference engines to perform real-time analysis of sensor data, or include hardware-accelerated video processing capabilities to support advanced video analytics at the network edge.

By processing data locally within the SoC, this edge computing technique may also help reduce the amount of data that needs to be transmitted to centralized cloud servers, potentially lowering bandwidth requirements and improving overall network efficiency. Additionally, it may enhance data privacy and security by enabling sensitive information to be processed locally rather than being sent to external systems for analysis.

In some examples, the method may further comprise configuring the gNB such that it supports both public and private spectrum operations. This dual-spectrum capability may provide enterprises with greater flexibility in deploying their dedicated 5G networks, enabling them to leverage both licensed and unlicensed frequency bands as needed. The gNB integrated into the SoC may be designed to operate across a wide range of frequencies, potentially including traditional cellular bands, newly allocated 5G spectrum, and unlicensed bands such as those used for Wi-Fi.

Supporting both public and private spectrum operations may offer several advantages. In scenarios where an enterprise has access to licensed spectrum, the gNB may utilize these dedicated frequencies to ensure reliable, high-quality service for potentially more important applications. Simultaneously, it may leverage unlicensed spectrum to provide additional capacity for less important traffic or to supplement coverage in areas where licensed spectrum may be limited. This hybrid technique may enable enterprises to optimize their use of available spectrum resources, potentially improving overall network performance and cost-efficiency.

Furthermore, the ability to operate in both public and private spectrum may facilitate smoother integration with existing wireless infrastructure and enable more flexible deployment models. For instance, an enterprise may start with a private network using unlicensed spectrum and later incorporate licensed spectrum as their needs grow or as spectrum becomes available, all without needing to replace the core network infrastructure.

In some examples, the method may further comprise implementing a shared memory architecture within the SoC that enables direct data exchange between network functions. This shared memory technique may significantly enhance the efficiency of inter-function communication within the integrated 5G network system. By enabling different network functions to access common memory areas, the system can potentially reduce latency and improve overall performance compared to traditional architectures where functions communicate through more complex interfaces.

The shared memory architecture may be particularly beneficial for functions that frequently exchange large amounts of data, such as the User Plane Function (UPF) and the gNodeB (gNB). For instance, when a user device sends data uplink, the gNB can write this data directly into a shared memory buffer, which the UPF can then access immediately without the need for time-consuming data copying or complex inter-process communication. This direct access may result in faster data processing and reduced system overhead.

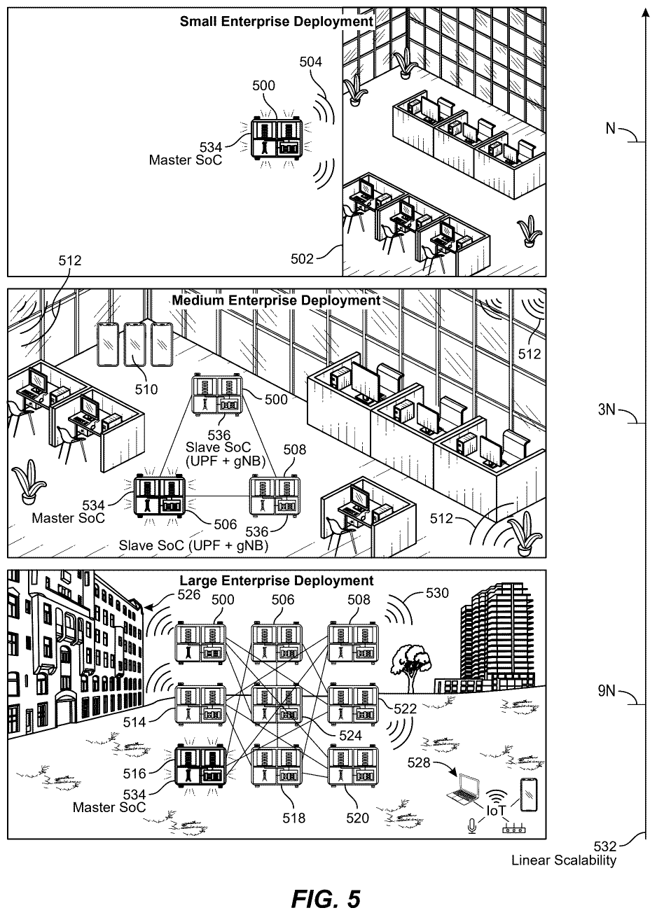

FIG. 5 illustrates the concept of linear scalability in a System-on-Chip (SoC) based dedicated 5G network deployment. The figure is divided into three vertical panels, each representing a different scale of deployment, demonstrating how the network may be expanded to meet varying enterprise needs. This multi-panel technique effectively showcases the potential flexibility and scalability of the SoC-based 5G network solution, which may be particularly beneficial for enterprises with evolving connectivity requirements or those planning for future growth. In some scenarios, this scalable architecture may enable organizations to start with a small, cost-effective deployment and gradually expand their network as needs grow, without requiring significant changes to the overall architecture. The linear nature of this scalability, as opposed to more complex exponential scaling models, may offer advantages in terms of predictable performance, simplified network planning, and potentially more efficient resource utilization as the network expands.

The top panel of FIG. 5 depicts a small-scale deployment, labeled “Small Enterprise Deployment”. In this panel, a single SoC 500 is shown in the center, utilizing the same design as presented in FIG. 4. Adjacent to the SoC, the figure illustrates a small office space with a few desks and computers 502. Wireless signals 504 are shown emanating from the SoC to the devices, representing the network coverage provided by this single-chip solution. This configuration may be suitable for small businesses or branch offices with limited space and modest connectivity needs. In such environments, the integrated nature of the SoC 500 may offer several potential benefits. For instance, the all-in-one design may simplify installation and maintenance, potentially reducing the need for specialized IT personnel. The compact form factor of the SoC 500 may also be advantageous in space-constrained office environments. In some embodiments, this single-SoC setup may provide sufficient coverage and capacity for a small team of employees, supporting various wireless devices and applications within the limited office area.

The middle panel illustrates a medium-scale deployment, labeled “Medium Enterprise Deployment”. This panel shows three SoCs (500, 506, 508) arranged in a triangular formation, connected by lines to indicate network integration. Surrounding these SoCs, the figure depicts a larger office space with more desks, computers, and mobile devices 510. Wireless signals 512 are shown covering a more extensive area, representing the increased network coverage and capacity provided by the multiple SoCs. This configuration may be suitable for medium-sized businesses or larger office spaces that require more comprehensive coverage and higher network capacity. The use of multiple SoCs in this scenario may offer several potential advantages. For example, the distributed nature of the SoCs may provide more uniform coverage throughout the office space, potentially reducing dead zones and improving overall network performance. In some embodiments, this multi-SoC arrangement may also offer enhanced reliability through redundancy, as the network may potentially continue to function even if one SoC experiences issues. The triangular formation of the SoCs may suggest a strategic placement to optimize coverage and capacity distribution across the office area.

The bottom panel represents a large-scale deployment, labeled “Large Enterprise Deployment”. This panel illustrates a grid of nine SoCs (500, 506, 508, 514, 516, 518, 520, 522, 524) arranged in a 3×3 formation. The SoCs are interconnected with a mesh of lines, indicating a more complex networking arrangement. Surrounding this grid, the figure depicts a large enterprise campus with multiple buildings 526, outdoor areas, and a variety of connected devices including smartphones, laptops, and IoT sensors 528. Extensive wireless coverage 530 is shown across the entire campus, representing the comprehensive network coverage provided by this large-scale deployment. This configuration may be suitable for large enterprises, university campuses, or industrial complexes with extensive coverage requirements and high-capacity needs. The use of multiple SoCs in this scenario may offer several potential benefits. For instance, the distributed nature of the SoCs may provide robust coverage across a large area, potentially supporting a high density of connected devices and diverse use cases. In some embodiments, this multi-SoC arrangement may also enable advanced features such as seamless handover between different areas of the campus, ensuring continuity of service for mobile users.

On the right side of FIG. 5, a vertical arrow labeled “Linear Scalability” 532 spans all three panels. Along this arrow, tick marks are added corresponding to each panel, labeled “N”, “3N”, and “9N” to represent the scaling factor. This visual element effectively illustrates the concept of linear scalability, showing how the network capacity may increase in proportion to the number of SoCs deployed. The linear nature of this scaling may offer several potential advantages for network planning and management. For example, it may enable more predictable performance as the network expands, potentially simplifying capacity planning and resource allocation. In some scenarios, this linear scalability model may also provide cost benefits, as organizations may potentially scale their network in a more granular and cost-effective manner, adding capacity only as needed rather than investing in oversized infrastructure upfront.

In each panel of FIG. 5, one SoC is highlighted and labeled as “Master SoC” 534. The other SoCs are labeled as “Slave SoC (UPF +gNB)” 536. This distinction between master and slave SoCs illustrates a potential hierarchical architecture within the network. The Master SoC 534 may contain the full set of 5G core functions, potentially serving as the central control point for the network. In some embodiments, this Master SoC may handle tasks such as overall network management, policy enforcement, and coordination between different network segments. The Slave SoCs 536, containing the User Plane Function (UPF) and gNodeB (gNB), may focus on extending coverage and capacity. This architecture may offer benefits in terms of efficient resource utilization and simplified network management. For instance, by centralizing core functions in the Master SoC, the system may reduce redundancy and potentially improve overall network efficiency. The distributed nature of the Slave SoCs may enable flexible coverage expansion and capacity enhancement in specific areas as needed.

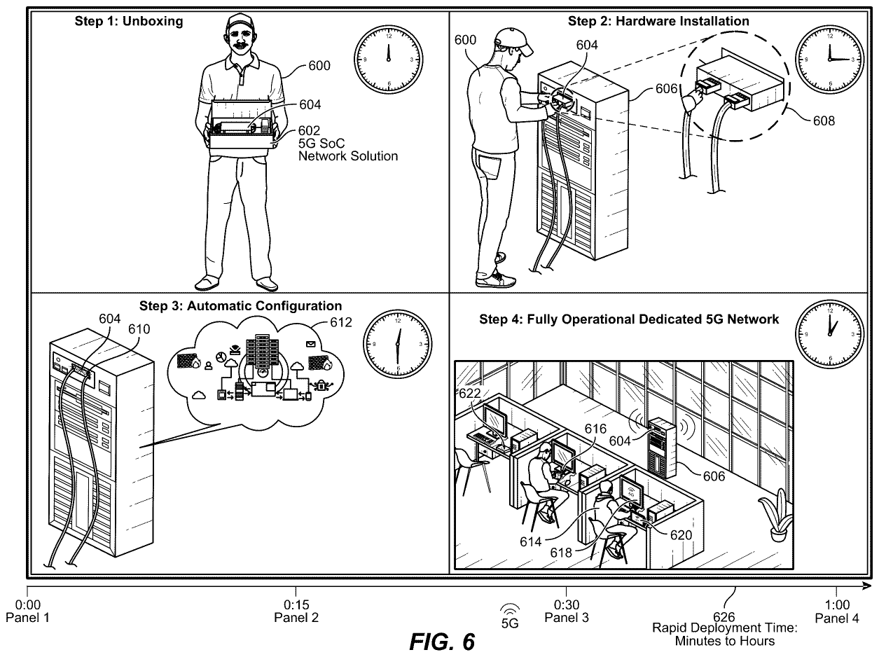

FIG. 6 illustrates a plug-and-play deployment process for a System-on-Chip (SoC) based dedicated 5G network in an enterprise setting. The figure is divided into four panels arranged in a 2×2 grid, each representing a different stage of the deployment process. This multi-panel technique effectively demonstrates the potential simplicity and speed of setting up a dedicated 5G network using the SoC solution. The figure may suggest that the deployment process may be completed in a relatively short time frame, potentially minimizing disruption to business operations and reducing the need for specialized technical expertise. In some scenarios, this streamlined deployment process may make dedicated 5G networks more accessible to a wider range of organizations, including those with limited in-house telecommunications expertise.

In some examples, the deployment process may begin with the unboxing of the SoC-based network solution, as shown in the top-left panel labeled “Step 1: Unboxing”. This panel depicts an IT technician 600 opening a box labeled “5G SoC Network Solution” 602. Inside the box, the SoC 604 is visible, along with some cables and a simple instruction manual. The inclusion of cables and an instruction manual in the package may suggest that the solution is designed for easy setup, potentially requiring minimal additional equipment or technical documentation. This technique may be particularly beneficial for organizations looking to deploy dedicated 5G networks without extensive preparatory work or specialized training. The simplicity of the unboxing process may also indicate that the SoC-based solution may be shipped and installed at remote locations with relative ease, potentially enabling rapid network deployment across multiple sites or branch offices.

The top-right panel, labeled “Step 2: Hardware Installation”, illustrates the physical installation of the SoC into the enterprise network infrastructure. This panel shows the same IT technician 600 inserting the SoC 604 into a slot in an enterprise-grade server or network appliance 606. A close-up view of the SoC being clicked into place is provided, along with a small inset showing the connection of network cables 608 to the device. This visual representation may suggest that the physical installation process may be straightforward, potentially requiring no more technical expertise than that needed for installing standard enterprise networking equipment. The use of a familiar form factor for the SoC, compatible with existing enterprise hardware, may facilitate integration with the organization's current infrastructure. In some embodiments, this compatibility may enable the SoC-based 5G network to coexist with or gradually replace existing networking solutions, providing a smooth transition path for enterprises adopting private 5G technology.

In some examples, the system may feature automatic configuration capabilities, as depicted in the bottom-left panel labeled “Step 3: Automatic Configuration”. This panel shows the installed SoC 604 with illuminated status LEDs 610, indicating that the device is powered on and operational. Above the device, a thought bubble contains a simplified network diagram 612, illustrating the SoC automatically detecting and configuring itself within the enterprise network. The diagram includes icons for firewalls, switches, and existing IT infrastructure, suggesting that the SoC may be capable of integrating seamlessly with various network elements. This automatic configuration feature may potentially reduce the complexity of network setup and minimize the risk of configuration errors. In some scenarios, this capability may enable rapid deployment of the dedicated 5G network without requiring extensive manual configuration or specialized knowledge of 5G network protocols. The system may be able to adapt to different network environments, potentially detecting available resources, optimizing its configuration for the specific enterprise setup, and applying appropriate security policies automatically.

The bottom-right panel, labeled “Step 4: Fully Operational Dedicated 5G network”, provides a wider view of the office space with the newly deployed 5G network in action. This panel shows several office workers 614 using various devices including smartphones 616, laptops 618, tablets 620, and IoT devices 622. In the background, the server or network appliance 606 with the installed SoC 604 is visible, emanating subtle radio wave lines to represent the broadcasting of the 5G signal. This comprehensive view may illustrate the potential impact of the dedicated 5G network on the enterprise environment, supporting a diverse range of devices and use cases. In some embodiments, the dedicated 5G network may provide enhanced connectivity for both traditional office equipment and emerging IoT devices, potentially enabling new applications and improving overall productivity. The seamless integration of the 5G network into the existing office environment may suggest that the transition to private 5G may be achieved with minimal disruption to ongoing business operations.

At the bottom of FIG. 6, a timeline arrow spans all four panels, labeled “Rapid Deployment Time: Minutes to Hours” 626. This visual element emphasizes the potential speed of the deployment process, suggesting that a fully operational dedicated 5G network may be achieved in a relatively short time frame. The rapid deployment capability may be particularly advantageous for organizations requiring quick setup of high-performance wireless networks, such as temporary project sites, pop-up retail locations, or emergency response scenarios. In some examples, this quick deployment process may also reduce downtime during network upgrades or expansions, minimizing the impact on business operations. The timeline may also imply that the SoC-based solution may offer significant time and cost savings compared to traditional 5G network deployments, which may require extensive planning, site surveys, and complex integration work.

To further illustrate the rapid nature of the deployment process, each panel in FIG. 6 includes a small clock icon showing the time elapsed: Panel 1 shows 0:00, Panel 2 shows 0:15, Panel 3 shows 0:30, and Panel 4 shows 1:00. This time progression may suggest that the entire deployment process may potentially be completed within an hour, from unboxing to full operation. In some scenarios, this rapid deployment capability may provide organizations with greater agility in responding to changing connectivity needs or taking advantage of new opportunities that require advanced wireless networking. The short deployment time may also reduce the need for extended periods of IT staff involvement, potentially freeing up resources for other important tasks and minimizing the overall cost of network implementation.

In some examples, the method may further comprise configuring the SoC such that it supports automated deployment processes that facilitate consistent user experience and service level agreement performance across multiple enterprise installations. This automated technique may significantly streamline the deployment and management of dedicated 5G networks, potentially reducing the need for specialized expertise and minimizing the risk of configuration errors. By incorporating pre-defined templates and self-optimization algorithms, the SoC-based system may adapt to various enterprise environments with minimal manual intervention.

The automated deployment processes may include features such as automatic network discovery, self-configuration, and dynamic optimization. For instance, when installed in a new enterprise environment, the SoC may automatically detect existing network infrastructure, assess available resources, and configure itself to operate optimally within that specific context. This may involve adjusting radio parameters, allocating network slices, and/or setting up appropriate security policies based on predefined best practices and enterprise-specific requirements.

In some examples, the method may further comprise implementing a self-discovery protocol on the SoC that automatically detects network topology or configures routing tables. This self-discovery capability may significantly simplify network setup and management, particularly in complex enterprise environments or multi-site deployments. When activated, the SoC may automatically scan its network environment, identifying other network elements, determining their capabilities, and establishing appropriate connections.

The self-discovery protocol might employ various techniques to map the network topology. For instance, it may use active probing methods to detect other SoCs, radio dots, or network switches in the vicinity. Alternatively, it might listen passively for network announcements or leverage existing network protocols to gather information about connected devices and their relationships. Based on the discovered topology, the SoC may then automatically configure its routing tables, optimizing data paths for efficient communication within the dedicated 5G network.

Furthermore, these automated processes may extend beyond initial deployment to ongoing network management and optimization. The system may continuously monitor network performance, user behavior, and environmental factors, automatically adjusting configurations to maintain consistent service quality. For example, if the system detects increased user density in a particular area of an enterprise campus, it may dynamically adjust radio resources or activate additional small cells to ensure consistent performance. This ongoing automation may help ensure that the network maintains optimal performance over time, even as enterprise needs evolve or network conditions change.

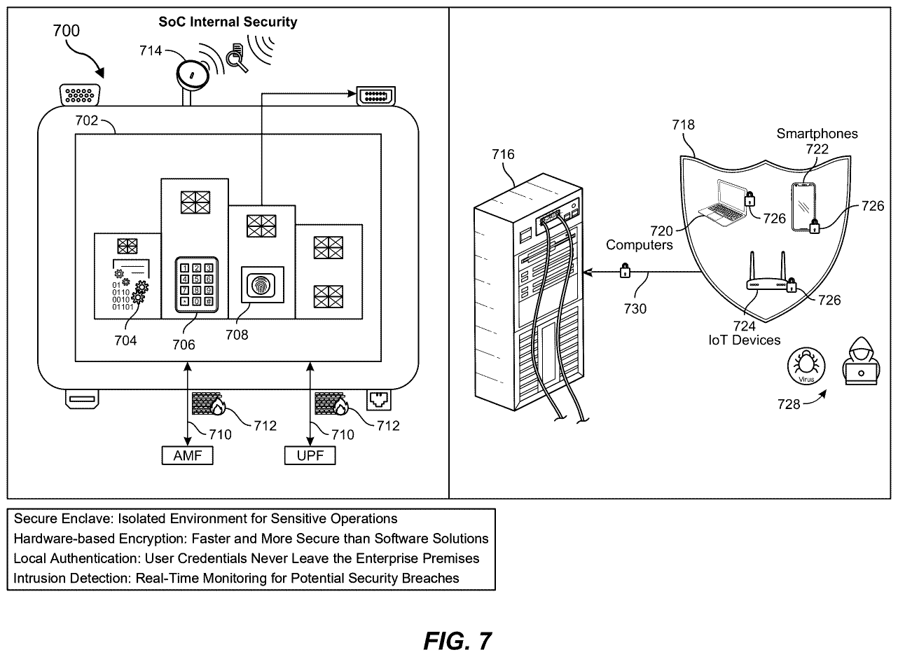

FIG. 7 illustrates the enhanced security features of the System-on-Chip (SoC) for a dedicated 5G network. The figure is divided into two main sections: the left side showing the SoC's internal security features, and the right side demonstrating its security benefits in an enterprise context. This comprehensive visualization may provide insights into how the SoC-based technique may potentially offer improved security measures compared to traditional distributed 5G network architectures. The integration of multiple security features within a single chip may suggest a more holistic and potentially more robust technique to network security, which may be particularly beneficial for enterprises handling sensitive data or operating in regulated industries.

On the left side of FIG. 7, a large, detailed view of the SoC 700 is presented, similar to the design shown in FIG. 4 but with a focus on security elements. At the center of the SoC, a prominent “Secure Enclave” 702 is illustrated as a fortress-like structure. This visual representation may emphasize the role of the Secure Enclave as a protected environment within the SoC, potentially isolated from other components to enhance security. In some embodiments, the Secure Enclave 702 may provide a trusted execution environment for sensitive operations, such as cryptographic functions or the handling of authentication data. The fortress-like depiction may suggest that this component is designed to resist various types of attacks, potentially including physical tampering or side-channel attacks. The central position of the Secure Enclave within the SoC may indicate its role in the overall security architecture of the dedicated 5G network.

Within the Secure Enclave 702, several key security components are depicted. The “Cryptographic Engine” 704 is represented as a series of interlocking gears with binary code on them. This visual may suggest the complex and dynamic nature of cryptographic operations performed within the SoC. In some scenarios, the Cryptographic Engine 704 may handle tasks such as encryption and decryption of data, generation of cryptographic keys, and secure hashing functions. The integration of this component within the Secure Enclave may provide an additional layer of protection for cryptographic operations, potentially making it more difficult for attackers to intercept or tamper with sensitive cryptographic material. The gear-like representation might also imply the interconnected nature of various cryptographic functions and their continuous operation to maintain network security.

Adjacent to the Cryptographic Engine 704, the figure shows a “Secure Key Storage” 706 illustrated as a vault with a digital lock. This representation may emphasize the important importance of securely storing cryptographic keys and other sensitive security parameters. In some embodiments, the Secure Key Storage 706 may utilize hardware-based security measures to protect stored keys from unauthorized access or tampering. The vault-like depiction indicates that this component provides a high level of isolation and protection for stored keys, potentially resistant to both software-based attacks and physical intrusion attempts. The digital lock may imply that access to the stored keys is tightly controlled and may require authentication or specific security protocols to be followed.

The third component within the Secure Enclave 702 is the “Authentication Vector Database” 708, depicted as a filing cabinet with a biometric scanner. This visual representation may suggest a secure repository for storing and managing authentication data for network users and devices. In some examples, the Authentication Vector Database 708 may contain information such as subscriber identities, cryptographic tokens, or biometric templates used for user authentication. The inclusion of a biometric scanner in the illustration indicates support for advanced authentication methods, potentially enabling for multi-factor authentication or biometric-based access control. The filing cabinet representation may suggest an organized and efficiently managed system for handling large numbers of authentication vectors, which may be particularly important for enterprise deployments with numerous users and devices.

Surrounding the Secure Enclave 702, the figure shows data paths 710 connecting to other SoC components, such as the Control Plane (CP) functions and User Plane (UP) functions discussed in previous figures. These data paths are shown passing through “Firewall” blocks 712, represented as brick walls with small gateways. This visualization illustrates how the SoC implements internal security measures to control and monitor data flow between different functional components. In some scenarios, these internal firewalls may help to compartmentalize different parts of the network, potentially limiting the spread of security breaches if one component is compromised. The brick wall representation might suggest robust protection, while the small gateways may imply tightly controlled and monitored data exchange between components.

At the edge of the SoC 700, an “Intrusion Detection System” 714 is depicted as a radar-like interface scanning incoming and outgoing data. This component may represent the SoC's capabilities for real-time monitoring and analysis of network traffic to detect potential security threats. In some embodiments, the Intrusion Detection System 714 may employ advanced algorithms to identify unusual patterns or known attack signatures in the data flowing in and out of the SoC. The radar-like representation might suggest continuous, 360-degree monitoring of network activity, potentially enabling for rapid detection and response to security threats. This real-time monitoring capability may be particularly valuable in enterprise environments where prompt identification of and response to security incidents is important.

The right side of FIG. 7 illustrates the security benefits of the SoC in an enterprise context. A central server rack 716 is shown with the SoC installed, emitting a protective shield 718 around the enterprise infrastructure. This visual representation may suggest the comprehensive security coverage provided by the SoC-based dedicated 5G network solution. In some scenarios, this protective shield may represent various security measures implemented by the SoC, such as encryption of all network traffic, access control policies, and real-time threat detection and mitigation. The shield emanating from the SoC may imply that security is centrally managed and consistently applied across the entire enterprise network, potentially simplifying security administration and reducing the risk of configuration errors that may lead to vulnerabilities.

Within the protective shield 718, several enterprise devices are depicted, including computers 720, smartphones 722, and IoT devices 724. Each of these devices is shown with a small lock icon 726 next to them, indicating secure connectivity. This representation may suggest that all devices connected to the dedicated 5G network benefit from the enhanced security features provided by the SoC. In some embodiments, this secure connectivity may include features such as device authentication, encrypted communications, and enforcement of network-wide security policies. The consistent application of security measures across diverse device types may be particularly beneficial in enterprise environments with a mix of traditional computing devices and IoT sensors or actuators.

Outside the protective shield 718, the figure shows menacing icons representing cyber threats 728, such as virus symbols and hacker figures, being blocked by the shield. This visualization may illustrate the SoC's potential capabilities in defending against various types of cyber attacks. The depiction of threats being blocked at the perimeter of the network may suggest a proactive security technique, potentially preventing malicious actors from gaining a foothold within the enterprise environment.

A data path 730 is shown connecting an enterprise device to the SoC, with small lock icons along the path to indicate end-to-end encryption. This representation may emphasize the secure nature of data transmission within the dedicated 5G network. In some scenarios, this end-to-end encryption may protect data from interception or tampering as it travels between devices and network infrastructure.

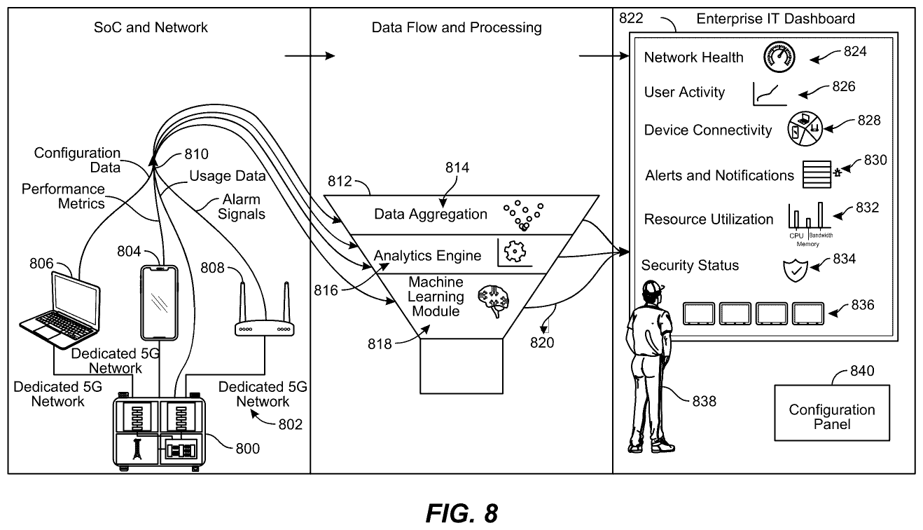

FIG. 8 illustrates a comprehensive view of how a System-on-Chip (SoC) based dedicated 5G network may integrate with enterprise IT systems for key performance indicator (KPI) monitoring and management functions. The figure is divided into three main sections: the left section showing the SoC and network, the center section depicting Data Flow and Processing, and the right section displaying an Enterprise IT Dashboard. This detailed representation may provide insights into the potential capabilities of the SoC-based solution for real-time monitoring, analysis, and management of the dedicated 5G network within an enterprise context. The integration of advanced analytics and machine learning capabilities, as shown in the figure, may suggest that the system may offer sophisticated tools for network optimization and proactive management, potentially enhancing the overall performance and reliability of the dedicated 5G network.

In the left section of FIG. 8, the SoC 800 is depicted at the bottom left corner, consistent with the design shown in previous figures. Above the SoC, a simplified dedicated 5G network 802 is illustrated, showing several connected devices including smartphones 804, laptops 806, and IoT sensors 808. This representation may emphasize the diverse range of devices that may be supported by the dedicated 5G network, potentially catering to various enterprise use cases from traditional office productivity to industrial IoT applications. The direct connection between the SoC 800 and the dedicated 5G network 802 may suggest tight integration between the core network functions and the devices, potentially enabling more efficient network management and resource allocation.

From the SoC 800 and dedicated 5G network 802, multiple data streams 810 are shown flowing towards the center section. These streams are labeled as “Performance Metrics,” “Usage Data,” “Alarm Signals,” and “Configuration Data.” This visualization may illustrate the comprehensive nature of the data collected by the SoC-based system, potentially providing a holistic view of network performance and usage. In some scenarios, these diverse data streams may enable more informed decision-making and proactive network management. For example, performance metrics may help identify bottlenecks or areas for optimization, while alarm signals may trigger immediate responses to potential issues, potentially minimizing network downtime.

In the center section of FIG. 8, a large funnel 812 is shown receiving the data streams from the left section. This funnel representation may suggest the system's capability to aggregate and consolidate diverse data inputs into a more manageable and actionable format. Below the funnel, a series of data processing steps are illustrated, beginning with “Data Aggregation” 814, represented by merging data points. This step may indicate the system's ability to combine and correlate data from various sources, potentially uncovering insights that might not be apparent when examining individual data streams in isolation. In some embodiments, this aggregation process may involve techniques such as data normalization, time-series alignment, or statistical aggregation to prepare the data for further analysis.

Following data aggregation, an “Analytics Engine” 816 is depicted as a gear with a graph inside. This representation may suggest the system's capability to perform complex analytical operations on the aggregated data. In some examples, the Analytics Engine 816 may employ various statistical or mathematical models to extract meaningful insights from the network data. These analytics may potentially include trend analysis, anomaly detection, capacity planning calculations, or performance forecasting. The gear-like representation might imply the continuous and automated nature of these analytical processes, potentially providing real-time or near-real-time insights into network performance and usage patterns.

The final processing step shown is a “Machine Learning Module” 818, represented by a brain icon with circuitry. This visualization may suggest the incorporation of advanced artificial intelligence capabilities into the network management system. In some scenarios, the Machine Learning Module 818 may enable predictive analytics, automated decision-making, or adaptive network optimization. For instance, it may be used to predict network congestion based on historical patterns and current trends, enabling for proactive resource allocation. The brain-like representation might imply the system's ability to learn and improve its performance over time, potentially becoming more accurate and efficient in its network management capabilities as it processes more data.

From these processing steps, refined data streams 820 are shown flowing to the right section of the figure. This flow may represent the transformation of raw network data into actionable insights and visualizations that can be presented to network administrators or integrated into automated management processes. The refinement of these data streams may potentially involve processes such as data summarization, insight extraction, or the generation of specific KPIs tailored to the enterprise's needs or preferences.

In some examples, the system may provide a comprehensive IT dashboard for monitoring and managing the dedicated 5G network. The right section of FIG. 8 illustrates this concept with a large monitor or wallscreen 822 displaying various elements of network performance and status. The “Network Health” 824 gauge shown on the dashboard may provide a high-level overview of the overall system status, potentially enabling administrators to quickly assess the general condition of the network. This may be particularly useful for rapid problem identification and prioritization of management tasks.

In some examples, the system may offer detailed insights into network usage patterns. The “User Activity” 826 line graph depicted on the dashboard may represent real-time or historical data on network utilization. This information may be valuable for capacity planning, identifying peak usage times, or detecting unusual activity patterns that might indicate security issues. The ability to visualize user activity over time may potentially help enterprises optimize their network resources and improve the overall user experience.

In some examples, the system may provide granular information about connected devices. The “Device Connectivity” 828 pie chart shown on the dashboard may offer a breakdown of the types of devices connected to the network. This information may be useful for managing device diversity, ensuring compatibility, and tailoring network policies to different device types. In an enterprise context, this capability may be particularly valuable for supporting bring-your-own-device (BYOD) policies or managing a diverse fleet of IoT devices.

In some examples, the system may include real-time alert functionality. The “Alerts and Notifications” 830 scrolling list displayed on the dashboard may provide immediate information about potential issues or notable events within the network. This feature may enable rapid response to important situations, potentially minimizing downtime and improving overall network reliability. The real-time nature of these alerts may be particularly beneficial in enterprise environments where network performance is closely tied to business operations.

In some examples, the system may offer detailed resource utilization metrics. The “Resource Utilization” 832 bar graphs shown on the dashboard, indicating CPU, memory, and bandwidth usage, may provide insights into the performance of various network components. This information may be valuable for identifying potential bottlenecks, planning upgrades, or optimizing resource allocation across the network. In an enterprise context, efficient resource utilization may translate to cost savings and improved network performance.

In some examples, the system may include robust security monitoring capabilities. The “Security Status” 834 shield icon with a checkmark or warning symbol displayed on the dashboard may provide a quick visual indicator of the network's security posture. This feature may potentially alert administrators to potential security threats or vulnerabilities, enabling prompt action to protect enterprise data and resources.

The figure also shows a row of smaller screens or tablets 836 below the main dashboard, displaying more detailed views of specific KPIs. This representation may suggest the system's ability to provide both high-level overviews and granular details on demand, potentially catering to different user roles or specific monitoring needs within the enterprise. An IT professional 838 is depicted standing in front of the dashboard, analyzing the data. This human element in the figure may emphasize the optional role of skilled personnel in interpreting and acting upon the insights provided by the system, potentially highlighting the balance between automated monitoring and human expertise in managing complex network environments.

Lastly, a “Configuration Panel” 840 is shown to the side of the dashboard, suggesting the ability to adjust network settings. This feature may imply that the system not only provides monitoring capabilities but also enables for direct management and reconfiguration of the network based on the insights gained from the dashboard. In some embodiments, this may enable rapid response to changing network conditions or business requirements, potentially enhancing the agility and adaptability of the enterprise network infrastructure.

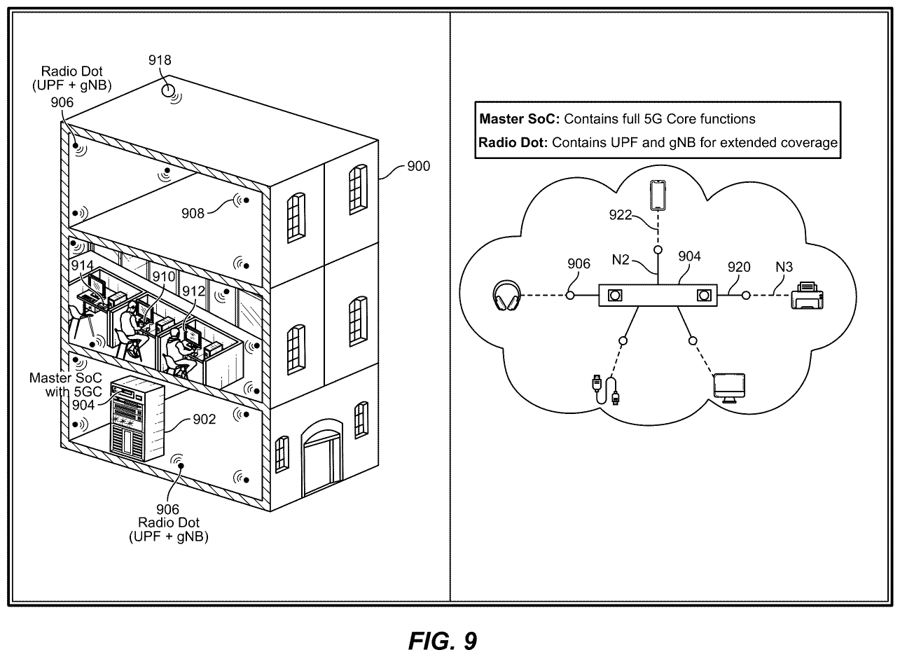

FIG. 9 illustrates a comprehensive view of how a System-on-Chip (SoC) may support the deployment of multiple radio dots in a dedicated 5G network setup. The figure is divided into two main sections: the left side showing a cutaway view of an enterprise building, and the right side displaying a simplified network topology diagram. This detailed representation may provide insights into the potential flexibility and scalability of the SoC-based solution for enterprise 5G deployments, particularly in complex or large-scale environments where comprehensive coverage and high capacity are required.

The left side of FIG. 9 shows a large, multi-story office building 900 with one side cut away to reveal the interior. This cutaway view may enable a clear visualization of how the SoC-based 5G network components may be distributed throughout a typical enterprise environment. On the ground floor, a server room 902 is depicted, containing a rack with the master SoC 904 installed. This master SoC is labeled as “Master SoC with 5GC,” suggesting that it may contain the full set of 5G Core (5GC) functions. The placement of the master SoC in a centralized server room may indicate its role as the primary control point for the entire dedicated 5G network, potentially providing centralized management and coordination for all network functions.

Throughout the building, multiple radio dots 906 are strategically placed. These radio dots are labeled as “Radio Dot (UPF+gNB),” indicating that they may contain both User Plane Function (UPF) and gNodeB (gNB) capabilities. The distribution of these radio dots across different floors and areas of the building may suggest a design technique aimed at providing comprehensive coverage and optimizing network performance throughout the enterprise space. Wireless signals 908 are shown emanating from each radio dot, visually representing the coverage areas provided by each unit. This representation may imply that the radio dot technique may enable flexible and granular coverage optimization, potentially addressing challenges such as signal attenuation due to building materials or varying density of users in different areas.

The figure also depicts various devices connected to the network, including smartphones 910, laptops 912, and IoT sensors 914, as well as potentially industrial equipment (not shown). This diverse range of connected devices may illustrate the versatility of the dedicated 5G network in supporting multiple use cases within an enterprise environment, from standard office productivity tools to specialized industrial applications. The representation of these devices throughout the building may suggest that the radio dot technique may provide consistent connectivity and performance across different areas and for various types of equipment.

In some examples, the system may support outdoor coverage extension. An external radio dot 918 is shown mounted on the roof of the building, which may indicate the capability to provide outdoor coverage or to extend the network to exterior areas of the enterprise campus. This feature may be particularly valuable for businesses with outdoor operations or those requiring seamless connectivity between indoor and outdoor spaces.

The right side of FIG. 9 presents a simplified network topology diagram, which may offer insights into the logical organization of the SoC-based dedicated 5G network. The master SoC 904 is positioned at the center of this diagram, potentially emphasizing its role as the central control point for the entire network. Radio dots, including a representative radio dot 906, are arranged in a star topology around the master SoC, which may suggest a hierarchical network structure with centralized management and distributed radio access points.

In some examples, the system may utilize different types of connections for control and user data. Solid lines 920 are used to show direct connections between the master SoC and each radio dot. These connections are labeled with “N2” and “N3” interfaces, which may represent the control plane and user plane interfaces, respectively, in 5G network architecture. The use of dedicated interfaces for control and user traffic may enable optimized network performance and more efficient resource allocation. Dashed lines 922 are used to represent wireless connections between radio dots and user devices, which may illustrate the final link in the network chain connecting end-users to the private 5G infrastructure.

In some examples, the system may employ a hierarchical architecture to optimize network performance and management. A small legend is included explaining the difference between the master SoC and radio dots: “Master SoC: Contains full 5G Core functions” and “Radio Dot: Contains UPF and gNB for extended coverage.” This distinction may highlight a design technique that centralizes core network functions while distributing radio access and user plane processing capabilities. Such an architecture may potentially offer benefits in terms of network scalability, performance optimization, and simplified management.

In some examples, the system may offer advanced tools for network planning and optimization. A visualization tool may use gradients to represent signal strength in different areas of the building, thereby serving as a valuable tool for network administrators in identifying coverage gaps, optimizing radio dot placement, and ensuring consistent performance across the enterprise space. The ability to visualize coverage in this manner may potentially simplify network planning and troubleshooting processes.

In some examples, the system may provide clear indicators of network capacity scaling. With a graphical interface, a capacity scaling indicator may show how adding more radio dots increases the overall network capacity. This feature may illustrate the linear scalability of the SoC-based technique, potentially enabling enterprises to easily expand their network capacity by deploying additional radio dots as needed. Such scalability may be particularly valuable for growing businesses or those with fluctuating connectivity demands.

In some embodiments, the System-on-Chip (SoC) may be configured to facilitate deployment of dedicated 5G networks with a level of simplicity comparable to Wi-Fi systems. This configuration may include pre-integrated network functions, automated setup procedures, and standardized interfaces that enable plug-and-play installation within enterprise environments. The SoC may incorporate self-configuration capabilities that automatically detect and adapt to the existing network infrastructure, potentially eliminating the need for extensive manual configuration or specialized technical expertise. This technique may significantly reduce the complexity and time required for deployment, potentially making dedicated 5G networks accessible to a broader range of organizations, including those without dedicated telecommunications expertise.

The SoC architecture may be designed to minimize or eliminate the need for interoperability testing and certification between different network components. By integrating multiple network functions into a single chip, the SoC may inherently ensure compatibility and coordinated operation of these functions, potentially reducing or eliminating the need for extensive integration testing that is typically required in distributed network architectures. This integrated technique may enable streamlined software updates, where all functions can be updated simultaneously, ensuring consistent compatibility across the entire system. The SoC may also incorporate standardized external interfaces that comply with established industry protocols, potentially simplifying integration with existing enterprise systems while reducing the need for custom interface development or extensive compatibility testing. Furthermore, the integrated nature of the SoC may eliminate the requirement for a 5G-aware application firewall between enterprise and operator domains, as all important or other network functions are contained within a single, secure environment. This elimination of inter-domain security measures may result in significant cost savings and reduced architectural complexity.

The SoC may be designed to support flexible deployment models and dynamic feature activation. In smaller deployments, a single SoC may provide full network functionality, while larger deployments may utilize multiple interconnected SoCs to extend coverage and capacity. The SoC may incorporate modular functionality, enabling for the activation or deactivation of specific network functions or capabilities based on deployment requirements. This modularity may be implemented through software-defined networking principles, potentially enabling for real-time adjustment of network capabilities without hardware modifications. The SoC architecture may be designed to be processor-agnostic, potentially supporting implementation on various hardware platforms, including but not limited to ARM-based processors. Additionally, the SoC design may adhere to cloud-native architecture principles, potentially enabling deployment in virtualized environments and facilitating integration with cloud-based management and orchestration systems. This cloud-native technique may enable greater scalability, easier updates, and more efficient resource utilization, potentially enabling the SoC to adapt to evolving enterprise needs and technological advancements.

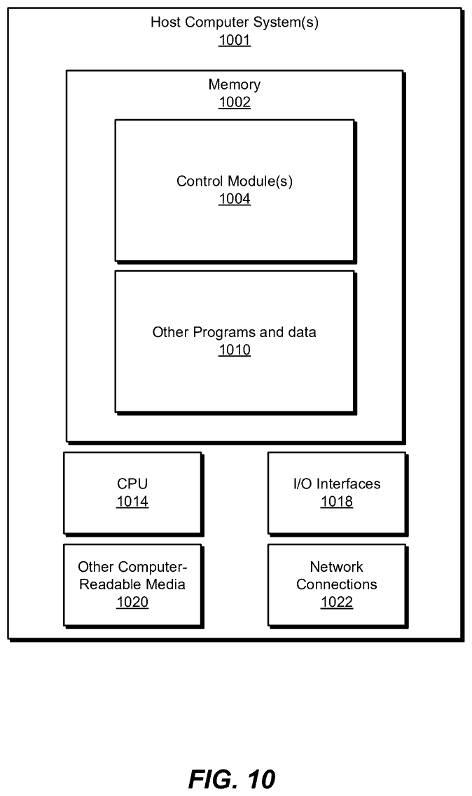

FIG. 10 shows a system diagram that describes an example embodiment of a computing system(s) for implementing embodiments described herein. The functionality described herein can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 10 illustrates an example of underlying hardware on which such software and functionality may be hosted and/or implemented.

In particular, shown is example host computer system(s) 1001. For example, such computer system(s) 1001 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1001 may include memory 1002, one or more central processing units (CPUs) 1014, I/O interfaces 1018, other computer-readable media 1020, and network connections 1022.

Memory 1002 may include one or more various types of non-volatile and/or volatile storage technologies. Examples of memory 1002 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1002 may be utilized to store information, including computer-readable instructions that are utilized by CPU 1014 to perform actions, including those of embodiments described herein.

Memory 1002 may have stored thereon control module(s) 1004. The control module(s) 1004 may be configured to implement and/or perform some or all of the functions of the systems or components described herein. Memory 1002 may also store other programs and data 1010, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1022 are configured to communicate with other computing devices to facilitate the functionality described herein. In various embodiments, the network connections 1022 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1018 may include a video interface, other data input or output interfaces, or the like. Other computer-readable media 1020 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
integrating, on a single System-on-Chip (SoC), a set of 5G or later generation core control plane (CP) functions, a set of 5G or later generation core user plane (UP) functions, a User Plane Function (UPF), and a gNodeB (gNB) for implementing radio access network functionality; and
configuring the set of CP functions, the set of UP functions, the UPF, and the gNB to communicate with each other within the SoC such that the SoC implements a dedicated 5G or later generation network.

2. The method of claim 1, further comprising implementing a standardized interface protocol on the SoC or pre-configuring network parameters such that the SoC enables plug-and-play deployment of the dedicated 5G or later generation network when connected to an enterprise network.

3. The method of claim 1, further comprising configuring the SoC such that the SoC supports linear scalability by enabling addition of multiple SoCs that each contain at least an instance of the UPF and an instance of the gNB.

4. The method of claim 1, further comprising implementing a hardware-based secure enclave within the SoC that isolates cryptographic operations or stores authentication vectors.

5. The method of claim 1, further comprising implementing a shared memory architecture within the SoC that enables direct data exchange between network functions.

6. The method of claim 1, further comprising providing an interface on the SoC for integration with enterprise IT systems for key performance indicator (KPI) monitoring or billing functions.

7. The method of claim 1, further comprising configuring the SoC such that the SoC supports automated deployment processes that facilitate consistent user experience and service level agreement performance across multiple enterprise installations.

8. The method of claim 1, further comprising implementing a real-time resource allocation algorithm on the SoC that dynamically adjusts computing resources between different network functions based on current network load or user demand.

9. The method of claim 1, further comprising configuring the SoC such that the SoC supports deployment of multiple radio dots.

10. The method of claim 1, further comprising implementing a self-discovery protocol on the SoC that automatically detects network topology or configures routing tables.

11. The method of claim 1, further comprising configuring the gNB such that the gNB supports both public and private spectrum operations.

12. The method of claim 1, further comprising implementing a virtualization layer on the SoC that partitions network resources into multiple isolated virtual networks.

13. The method of claim 1, further comprising integrating edge computing capabilities within the SoC to support low-latency applications.

14. The method of claim 1, further comprising optimizing the integrated functions to support massive Machine Type Communications (mMTC) for IoT devices.

15. The method of claim 1, further comprising implementing Quality of Service (QoS) management functionality at a hardware level within the SoC.

16. The method of claim 1, further comprising implementing an interface within the SoC to support interoperability with legacy 3G or 4G systems.

17. A non-transitory computer-readable medium that has instructions stored thereon that, when executed by at least one physical computing processor, cause a computing device to perform operations comprising:
integrating, on a single System-on-Chip (SoC), a set of 5G or later generation core control plane (CP) functions, a set of 5G or later generation core user plane (UP) functions, a User Plane Function (UPF), and a gNodeB (gNB) for implementing radio access network functionality; and
configuring the set of CP functions, the set of UP functions, the UPF, and the gNB to communicate with each other within the SoC such that the SoC implements a dedicated 5G or later generation network.

18. The non-transitory computer-readable medium of claim 17, wherein the operations further comprise implementing a standardized interface protocol on the SoC and pre-configuring network parameters such that the SoC enables plug-and-play deployment of the dedicated 5G or later generation network when connected to an enterprise network.

19. A System-on-Chip comprising:
a set of 5G or later generation core control plane (CP) functions, a set of 5G or later generation core user plane (UP) functions, a User Plane Function (UPF), and a gNodeB (gNB) for implementing radio access network functionality, wherein the set of CP functions, the set of UP functions, the UPF, and the gNB are configured to communicate with each other within the SoC such that the SoC enables a dedicated 5G or later generation network.

20. The System-on-Chip of claim 19, wherein a standardized interface protocol is implemented on the SoC or network parameters are pre-configured such that the SoC enables plug-and-play deployment of the dedicated 5G or later generation network when connected to an enterprise network.
